(19) United States
(12) Patent Application Publication
(10) Pub. No.: US 2014/0063877 A1
(43) Pub. Date: Mar. 6, 2014

(54) POWER CONVERSION APPARATUS

(71) Applicant: Satoshi Taira, Chiyoda-ku (JP)

(72) Inventor: Satoshi Taira, Chiyoda-ku (JP)

(73) Assignee: MITSUBISHI ELECTRIC CORPORATION, Chiyoda-ku, Tokyo (JP)

(21) Appl. No.: 14/114,985

(22) PCT Filed: Aug. 1, 2011
(86) PCT No.: PCT/JP2011/067595

§ 371 Date: Oct. 31, 2013

(51) Int. Cl. H02M 7/23

(52) U.S. Cl. CPC H02M 7/23
USPC 363/70

(57) ABSTRACT

A power conversion apparatus according to the present invention includes a plurality of PWM converters (2 and 3) that are connected in parallel and convert power supplied from a common three-phase AC power supply (1) into DC power and, and supply the DC power to a common load (6) and a plurality of short-circuit prevention reactors (10 and 11) that are connected to an output side of a part or all of the PWM converters (2 and 3) and, when a deviation occurs in operation timings of switching elements of a same phase in the respective PWM converters, reduce a short-circuit current flowing between PWM converters with mismatched operation timings.

### FIELD

The present invention relates to a power conversion apparatus that is constituted by PWM converters connected in parallel.

### BACKGROUND

Generally, when PWM converters are connected in parallel, it is ideal for switching elements to be connected in parallel to operate at the same timing. However, in practice, a deviation occurs in the operation timing due to variations of the switching elements and driving circuits for driving these elements. When a deviation occurs in the operation timing of the switching elements to be connected in parallel, for example, in a case of a device configuration shown in FIG. 14, a trouble of short-circuit of P (a positive side) and N (a negative side) may occur, so that a short-circuit current may flow through a path indicated by the arrow line (thick line).

The power conversion apparatus shown in FIG. 14 has a configuration for receiving a power supply from a three-phase AC power supply 1, generating DC power, and supplying the DC power to a load 6, and includes PWM converters 2 and 3 connected in parallel. The PWM converter 2 includes a filter reactor 4, and the PWM converter 3 includes a filter reactor 5. Each of the filter reactors 4 and 5 often uses reactors that are normally magnetically three-phase coupled to each other. The reactors that are magnetically three-phase coupled have an inductance with respect to a normal mode current; however, the inductance is significantly decreased with respect to a common mode current. The short-circuit current shown in FIG. 14 is a common mode current, and thus the filter reactors 4 and 5 can hardly prevent the short-circuit current.

Consequently, conventionally, short-circuit prevention reactors 7 to 9 are added to all three phases of an alternate-current side as shown in FIG. 15 in order to prevent the trouble of the short circuit of P and N. The short-circuit prevention reactors 7 to 9 are not magnetically coupled to each other.

As a technique of reducing a short-circuit current between converters connected in parallel, in Patent Literature 1 mentioned below, a circuit for suppressing a cross current flowing between power conversion apparatuses connected in parallel by a reactor is disclosed, although it differs from the case of connecting PWM converters in parallel.

### CITATION LIST

### Patent Literature

Patent Literature 1: Japanese Patent Application Laid-open No. 2001-177997

### SUMMARY

### Technical Problem

As described above, conventionally, a short-circuit current is prevented by using the short-circuit prevention reactors 7 to 9 as shown in FIG. 15; however, loss is increased because a high frequency current due to switching flows through the short-circuit prevention reactors, and the size and cost are likely to be increased. Furthermore, because three short-circuit prevention reactors are required, it is disadvantageous in terms of mounting space for the short-circuit prevention reactors and economic efficiency.

The present invention has been achieved in view of the above problems, and an object of the present invention is to obtain a power conversion apparatus that can achieve downsizing and low cost of short-circuit prevention reactors as compared to conventional techniques and further achieve reduction of the number of short-circuit prevention reactors required for each apparatus.

### Solution to Problem

To solve the above problems and achieve the object, a power conversion apparatus according to an aspect of the present invention includes: a plurality of PWM converters that are connected in parallel and convert power supplied from a common three-phase AC power supply into DC power, and supply the DC power to a common load; and a plurality of short-circuit prevention reactors that are connected to an output side of a part or all of the PWM converters. When a deviation occurs in operation timings of switching elements of a same phase in the respective PWM converters, the plurality of short-circuit prevention reactors reduce a short-circuit current flowing between PWM converters with mismatched operation timings.

### Advantageous Effects of Invention

According to the power conversion apparatus of the present invention, it is possible to reduce the number of short-circuit prevention reactors and to achieve low cost and downsizing of the short-circuit prevention reactors, thereby eventually achieving downsizing of the apparatus.

### BRIEF DESCRIPTION OF DRAWINGS

FIG. 1 is a configuration example of a power conversion apparatus according to a first embodiment of the present invention.

FIG. 2 is an explanatory diagram of an effect of the power conversion apparatus according to the first embodiment.

FIG. 3 is an explanatory diagram of an effect of the power conversion apparatus according to the first embodiment.

FIG. 4 is a configuration example of a power conversion apparatus according to a second embodiment.

FIG. 5 is a configuration diagram of a short-circuit prevention reactor according to the second embodiment.

FIG. 6 is an explanatory diagram of an operation of the short-circuit prevention reactor according to the second embodiment.

FIG. 7 is an explanatory diagram of an operation of the short-circuit prevention reactor according to the second embodiment.

FIG. 8 is an explanatory diagram of an effect of the power conversion apparatus according to the second embodiment.

FIG. 9 is an explanatory diagram of an effect of the power conversion apparatus according to the second embodiment.

FIG. 10 is an explanatory diagram of an effect of the power conversion apparatus according to the second embodiment.

FIG. 11 is an explanatory diagram of an effect of the power conversion apparatus according to the second embodiment.

FIG. 12 is a device configuration example of a case where three PWM converters are connected in parallel.

FIG. 13 is a device configuration example of a case where three PWM converters are connected in parallel.

FIG. 14 is an explanatory diagram of a conventional power conversion apparatus.

FIG. 15 is an explanatory diagram of the conventional power conversion apparatus.

### DESCRIPTION OF EMBODIMENTS

Exemplary embodiments of a power conversion apparatus according to the present invention will be explained below in detail with reference to the accompanying drawings. The present invention is not limited to the embodiments.

### First Embodiment

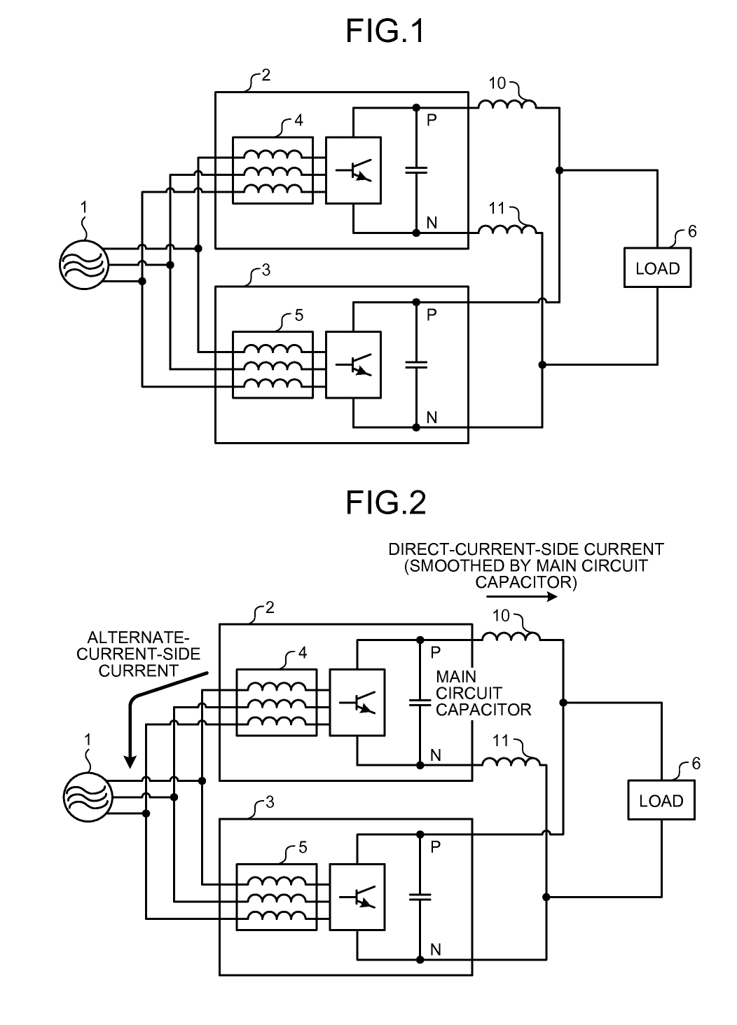

FIG. 1 is a configuration example of a power conversion apparatus according to a first embodiment of the present invention. The power conversion apparatus according to the present embodiment includes: a plurality of PWM converters 2 and 3 that convert AC power supplied from the three-phase AC power supply 1 into DC power based on a PWM control; and short-circuit prevention reactors 10 and 11 respectively provided between output terminals (P and N) of the PWM converter 2 and the load 6 that receives a power supply from the respective PWM converters.

The PWM converters 2 and 3 include the filter reactors 4 and 5, respectively, and each of the filter reactors 4 and 5 includes three reactors provided for the power of each phase supplied from the three-phase AC power supply 1. The three reactors are magnetically coupled to each other. Switching elements of the same phase of the PWM converters 2 and 3 are controlled by a control circuit (not shown) such that operation timings thereof match each other. However, in practice, a deviation often occurs in the operation timing due to a variation of performance of the element itself or a variation of a driving circuit.

It is assumed here that the short-circuit prevention reactors 10 and 11 are not magnetically coupled to each other. In the power conversion apparatus according to the present embodiment, the short-circuit prevention reactors 10 and 11 reduce a short-circuit current caused by a deviation of the operation timing between the switching elements of respective PWM converters.

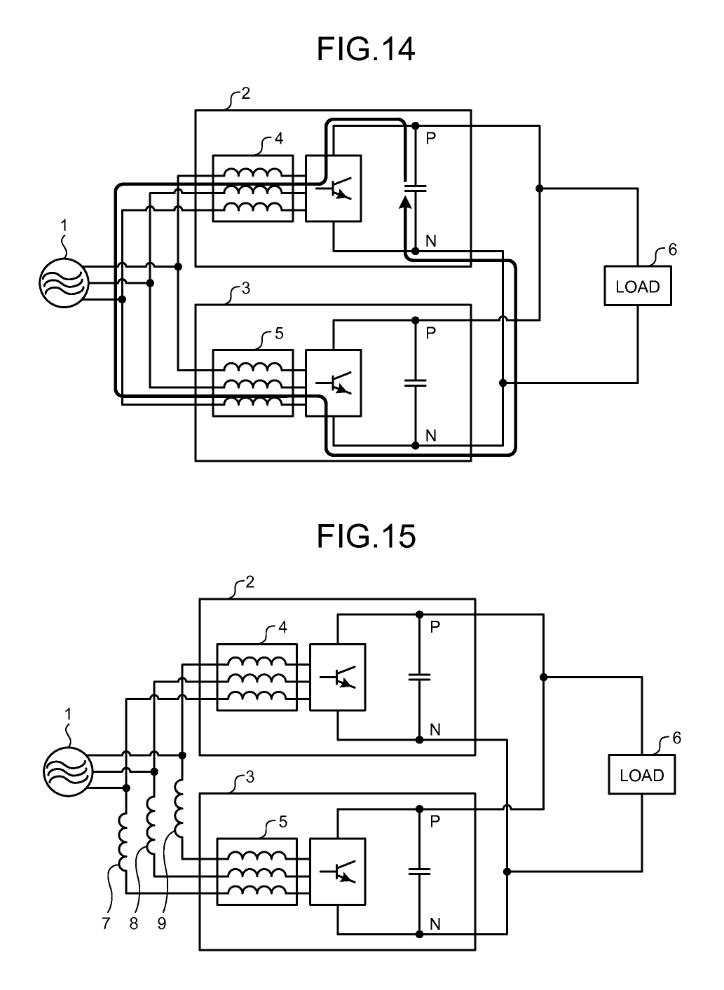

A path through which the short-circuit current flows includes, in addition to the path shown in FIG. 14, for example, a path passing through P of the PWM converter 2 from a capacitor of the PWM converter 3, further passing through the switching element and the filter reactor 4, returning to the PWM converter 3, passing through the filter reactor 5 and the switching element, and then returning to the capacitor. The short-circuit current flowing through the above described path is reduced by the short-circuit prevention reactor 10.

Effects obtained by the power conversion apparatus according to the present embodiment are explained below.

As described above, in the power conversion apparatus according to the present embodiment, the short-circuit prevention reactors 10 and 11 are connected to an output side (a direct-current side). Therefore, as described above, the short-circuit current can be reduced with less short-circuit prevention reactors as compared to a conventional power conversion apparatus including short-circuit prevention reactors on the alternate-current side.

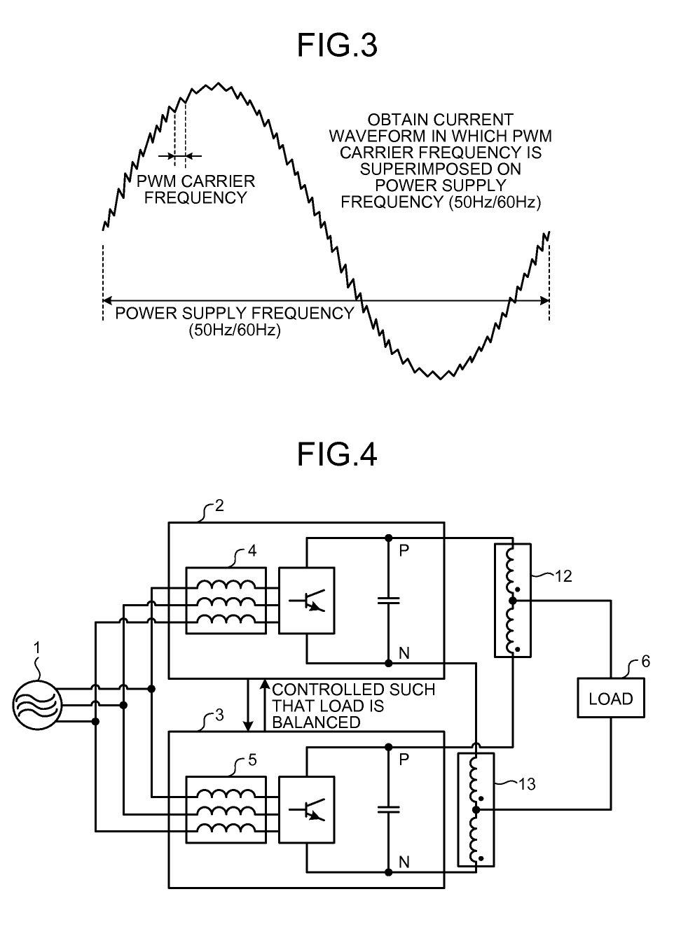

As shown in FIG. 3, an alternate-current-side current shown in FIG. 2 has a current waveform in which a PWM carrier frequency is superimposed on a power supply frequency (50 hertz/60 hertz). While iron loss of the reactor is divided into hysteresis loss and eddy-current loss, the hysteresis loss and the eddy-current loss are proportional to the 1.6th power of the frequency and the square of the frequency, respectively. Therefore, when the current superimposed with such a high frequency current flows, the loss is increased. On the other hand, because the power supply frequency (50 hertz/60 hertz) is not applied to the direct-current-side current shown in FIG. 2 and the direct-current-side current is smoothed by a main circuit capacitor in the PWM converter, the high frequency current of the PWM carrier frequency component is greatly reduced. Therefore, the iron loss of the reactor can be greatly reduced. That is, an iron core used in the reactor can be replaced by a core of an inexpensive material, so that low cost of the reactor can be achieved. Alternatively, the core can be reduced in size, so that downsizing and low cost of the reactor can be achieved.

As described above, according to the present embodiment, the short-circuit prevention reactors are arranged on the output side (the direct-current side) of some of the PM converters in order to prevent the short-circuit current. Therefore, the number of short-circuit prevention reactors can be reduced, and at the same time, low cost and downsizing of the short-circuit prevention reactor can be achieved. Accordingly, the apparatus can be downsized. In a case of a power conversion apparatus having a configuration in which two PWM converters are connected in parallel as shown in FIG. 1, it suffices to arrange the short-circuit prevention reactors on the P and N output side of one of the PWM converters, and thus the number of short-circuit prevention reactors can be reduced to two, which has been three in conventional techniques.

While FIG. 1 depicts a configuration in which the short-circuit prevention reactors 10 and 11 are connected to P and N on the side of the PWM converter 2, one of the short-circuit prevention reactors may be connected to the side of the PWM converter 3. That is, the short-circuit prevention reactor 10 can be connected to the P side of the PWM converter 3. Alternatively, the short-circuit prevention reactor 11 can be connected to the N side of the PWM converter 3.

### Second Embodiment

FIG. 4 is a configuration example of a power conversion apparatus according to a second embodiment. In the power conversion apparatus according to the present embodiment, the short-circuit prevention reactors 10 and 11 of the power conversion apparatus according to the first embodiment (see FIG. 1) are replaced with short-circuit prevention reactors 12 and 13. The PWM converters 2 and 3 are normally controlled to take a balance in each other's currents. Features other than the above are identical to those of the first embodiment. In the present embodiment, only features different from the first embodiment are explained.

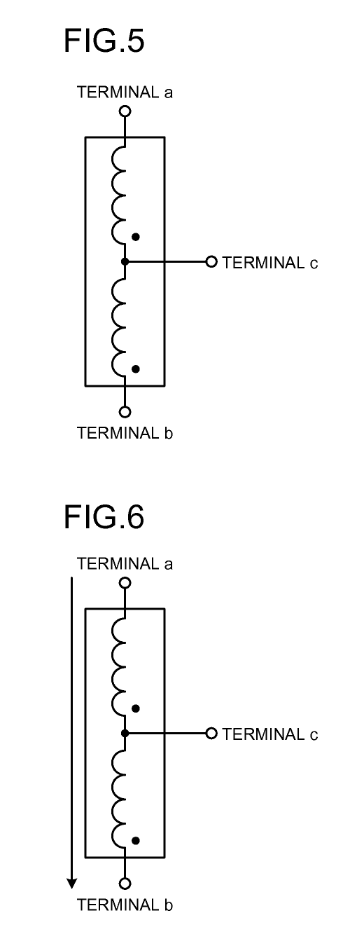

The short-circuit prevention reactors 12 and 13 are explained with reference to FIGS. 5 to 7. Each of the short-circuit prevention reactors 12 and 13 included in the power conversion apparatus according to the present embodiment has a configuration shown in FIG. 5, where a terminal (an electrode) a and a terminal b at both ends are connected to the P side or the N side of the PWM converter to be connected in parallel. A terminal c drawn from an intermediate point of the short-circuit prevention reactor is connected to the load 6.

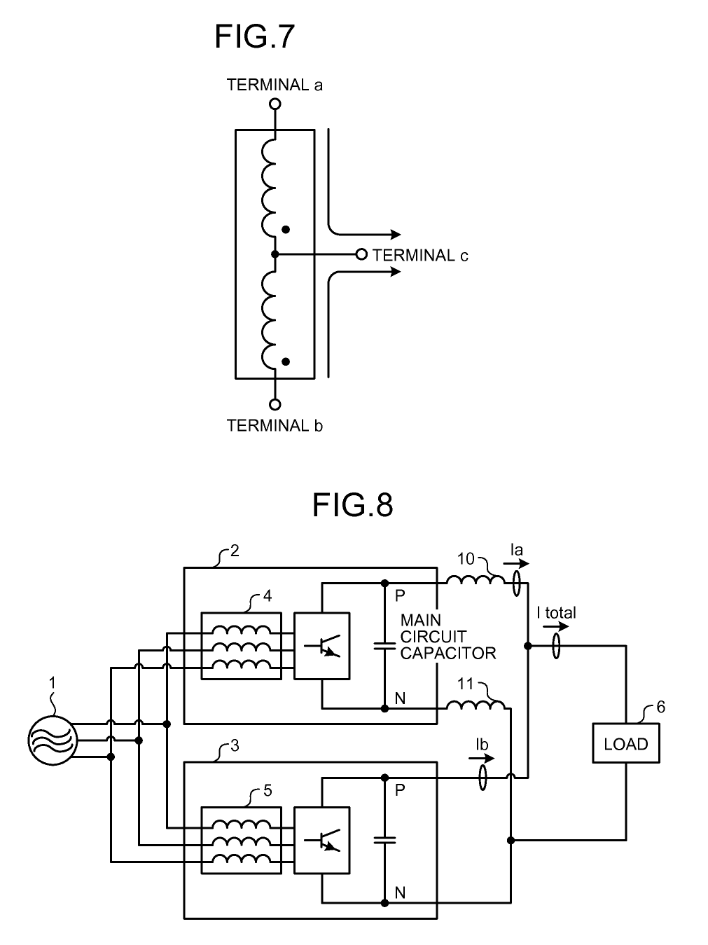

When a current flows from the terminal a to the terminal b or vice versa as shown in FIG. 6, each of the short-circuit prevention reactors 12 and 13 has an inductance with respect to such a current; however, when a current flowing from the terminal a to the terminal c and a current flowing from the terminal b to the terminal c have the same magnitude as shown in FIG. 7, magnetic fluxes are canceled out with each other, and thus each of the short-circuit prevention reactors 12 and 13 has characteristics of not having any inductance with respect to such a current.

Because the configuration described above is applied, the power conversion apparatus according to the present embodiment can achieve effects identical to those of the power conversion apparatus according to the first embodiment, as well as the following effects.

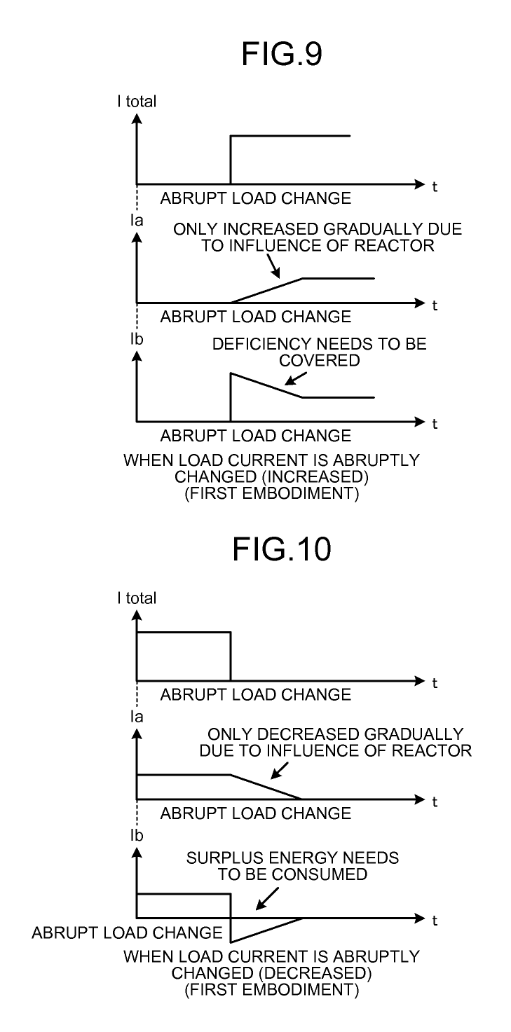

A case where a load current is abruptly changed (increased) when a current conversion apparatus according to the first embodiment (see FIG. 1) is applied is assumed here. Because the PWM converter 2 includes the short-circuit prevention reactors 10 and 11, even when the load current is abruptly increased, the current flowing from the PWM converter 2 to the load 6 (a current Ia shown in FIG. 8) is only increased gradually. Therefore, a deficiency needs to be covered by a current Ib flowing from the PWM converter 3 to which no short-circuit prevention reactor is connected (see FIG. 9); however, the PWM converters operated in parallel are normally controlled to take a balance in each other's currents. Therefore, when the deficient current is covered by the current Ib, a dedicated current control process is needed. Furthermore, in order to prevent a deficiency of a rated current of the PWM converter 3, any one of the following measures needs to be taken.
Not allow an abrupt load change to happen.
Not use the power conversion apparatus with 100% load, but use the apparatus with a margin.
Set the rated current of the PWM converter 3 larger than that of the PWM converter 2 (→cannot be shared with the PWM converter 2).

Similarly, when the load is abruptly changed (decreased), the current Ia flowing from the PWM converter 2 to the load 6 is only decreased gradually (see FIG. 10). Therefore, a surplus energy needs to be consumed by the PWM converter 3.

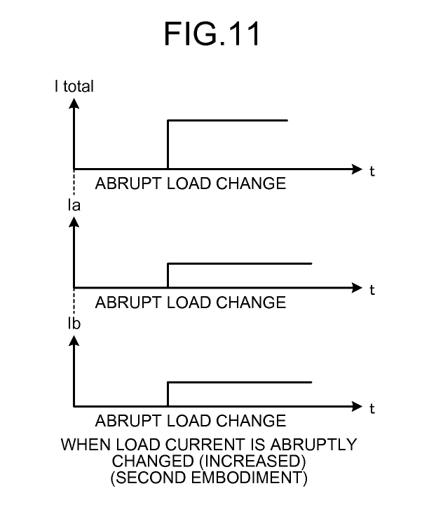

On the other hand, in the power conversion apparatus according to the present embodiment, the short-circuit prevention reactors 12 and 13 are connected to the output sides of both the PWM converters 2 and 3. Furthermore, a control is performed such that the currents (Ia and Ib) flowing from the PWM converters to the load 6 are balanced. As described above, when the current flowing from the terminal a to the terminal c and the current flowing from the terminal b to the terminal c have the same value, the short-circuit prevention reactors 12 and 13 do not have any inductance with respect to the current flowing through the load 6. Therefore, there is no such phenomenon as that happening in the power conversion apparatus according to the first embodiment when the load is abruptly changed (see FIG. 11). Thus, the dedicated current control process for covering the deficient current with the current Ib is not necessary when the load current is abruptly changed (increased). Accordingly, the power conversion apparatus according to the present embodiment can use the 100% load and achieve sharing of the PWM converters 2 and 3.

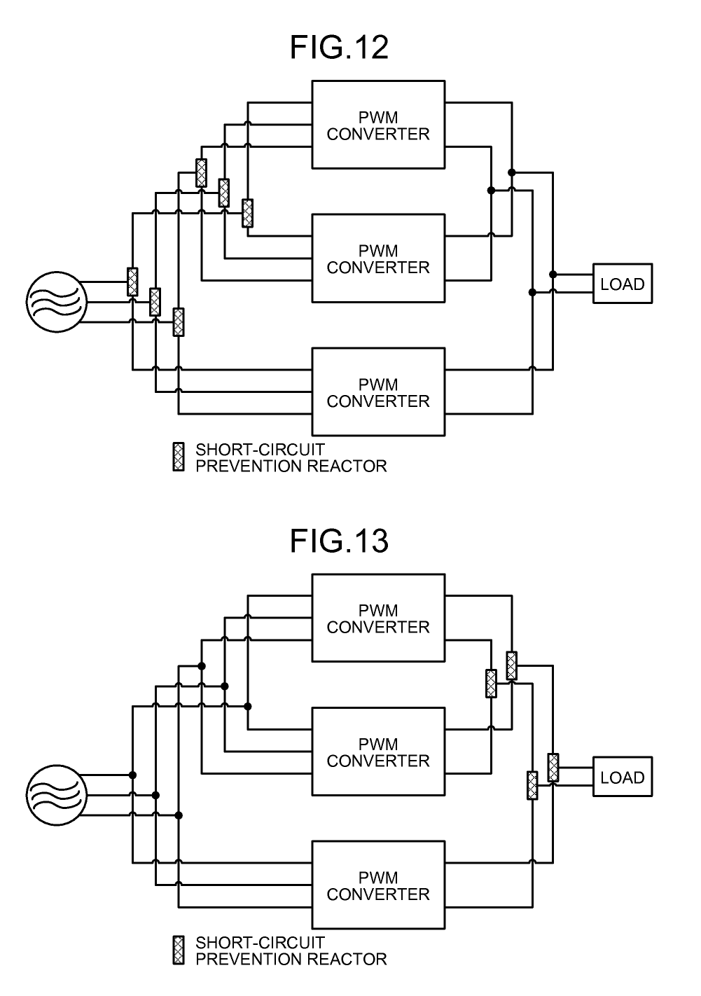

In the first and second embodiments, although there has been explained an example of constituting a power conversion apparatus by two PWM converters connected in parallel for simplifying explanations, the number of PWM converters to be connected in parallel can be three or more. In the first embodiment, when n PWM converters are connected in parallel, it suffices that short-circuit prevention reactors are connected to the P and N outputs of n−1 PWM converters. Furthermore, in the second embodiment, it suffices that one of the two terminals (the terminal a and the terminal b) at the both ends of the short-circuit prevention reactor shown in FIG. 5 is connected to the P output (or the N output) of the PWM converter and the other terminal is connected to the P output (or the N output) of the other PWM converter or the intermediate point (the terminal c) of the other PWM converter (see FIG. 12). FIG. 12 is an example of a case where three PWM converters are connected in parallel; however, the same holds true for a case of connecting four or more PWM converters in parallel. As compared to a case of connecting short-circuit prevention reactors to the input side of the three-phase AC power supply (see FIG. 13), the case of connecting the short-circuit prevention reactors to the DC power output side can reduce the required number of short-circuit prevention reactors. In addition, because the DC power output side is a path through which no ripple current (a pulsed current) flows as described above, downsizing and low cost of the short-circuit prevention reactors can be achieved.

### INDUSTRIAL APPLICABILITY

As described above, the power conversion apparatus according to the present invention is useful as a power conversion apparatus that is constituted by a plurality of PWM converters connected in parallel, and is particularly suitable for a power conversion apparatus that can achieve reduction of the required number of reactors for reducing a P-N short-circuit current and downsizing of the reactor.

### REFERENCE SIGNS LIST

1 three-phase AC power supply

2, 3 PWM converter

4, 5 filter reactor

6 load

7, 8, 9, 10, 11, 12, 13 short-circuit prevention reactor

1. A power conversion apparatus comprising:
a plurality of PWM converters that are connected in parallel and convert power supplied from a common three-phase AC power supply into DC power, and supply the DC power to a common load; and
a plurality of short-circuit prevention reactors that are connected to an output side of a part or all of the PWM converters, wherein
when a deviation occurs in operation timings of switching elements of a same phase in the respective PWM converters, the plurality of short-circuit prevention reactors reduce a short-circuit current flowing between PWM converters with mismatched operation timings.

2. The power conversion apparatus according to claim 1, wherein
when there are n PWM converters to be connected in parallel,
the short-circuit prevention reactors are respectively connected to P output terminals and N output terminals of n−1 PWM converters.

3. The power conversion apparatus according to claim 1, wherein
when there are n PWM converters to be connected in parallel,
the short-circuit prevention reactors are connected to P output terminals of n−1 PWM converters, and the short-circuit prevention reactors are connected to N output terminals of the n−1 PWM converters.

4. (canceled)

5. The power conversion apparatus according to claim 1, wherein
each of the short-circuit prevention reactors includes:
two terminals respectively connected to both ends of the short-circuit prevention reactor; and
one terminal connected to an intermediate point of the short-circuit prevention reactor, wherein
the plurality of short-circuit prevention reactors includes:
a first short-circuit prevention reactor whose the two terminals are respectively connected to a P output of two individual PWM converters among the plurality of PWM converters, and the terminal of the intermediate point is connected to the intermediate point of another short-circuit prevention reactor;
a second short-circuit prevention reactor whose the two terminals are respectively connected to an N output of two individual PWM converters among the plurality of PWM converters, and the terminal of the intermediate point is connected to the intermediate point of another short-circuit prevention reactor; and
a third short-circuit prevention reactor whose:
the two terminals are configured such that any one of the two terminals at the both ends is connected to any one of an N output and a P output of an arbitrary PWM converter and the other terminal is connected to the intermediate point of the other short-circuit prevention reactor; and
the one terminal of the intermediate point is connected to a load.
